(19) United States
(12) Patent Application Publication
(10) Pub. No.: US 2011/0162189 A1
(43) Pub. Date: Jul. 7, 2011

(54) COMPONENT MOUNTING DEVICE AND COMPONENT MOUNTING METHOD

(75) Inventor: Kazuhiko Noda, Yamanashi (JP)

(73) Assignee: PANASONIC CORPORATION, Osaka (JP)

(21) Appl. No.: 13/119,816

(22) PCT Filed: Sep. 14, 2009
(86) PCT No.: PCT/JP2009/004581

§ 371 Date: Mar. 18, 2011

(30) Foreign Application Priority Data
Sep. 19, 2008 (JP) 2008-240464

(51) Int. Cl. B23P 11/00; B23P 19/00

(52) U.S. Cl. 29/428; 29/700

(57) ABSTRACT

Provided is a component mounting device and a component mounting method in which three stages, i.e. a component supply stage, a component intermediate stage and a component mounting stage are disposed properly to achieve efficient movement of a pickup head and a mounting head to thereby improve production efficiency.

The component mounting device includes: a pickup head 5 which picks up a chip 4 from a wafer sheet holder 2; a chip intermediate table 6 on which the picked-up chip 4 is temporarily placed; a mounting head 7 which receives the chip 4 temporarily placed on the chip intermediate table 6; and a board support table 9 on which the chip 4 received by the mounting head 7 is mounted on a board 8; wherein: the chip intermediate table 6 is disposed at a height between the wafer sheet holder 2 and the board support table 9 to keep the balance between moving times of the pickup head 5 and the mounting head 7.

### TECHNICAL FIELD

The present invention relates to a component mounting device and a component mounting method in which a component such as a die separated as an individual piece by dicing a silicon wafer is mounted on a board.

### BACKGROUND ART

A die bonding device heretofore includes three work stages, i.e. a component supply stage which supplies a die (component) separated as an individual piece by dicing a laminated silicon wafer, a component intermediate stage on which the die picked up from the component supply stage by a pickup head is temporarily placed to be transferred to a mounting head, and a component mounting stage on which the die is bonded to a board by the mounting head. The component intermediate stage is used when the die is mounted face-up. When the die is to be mounted face-down, the pickup head is turned upside down so that the die having a face-down posture is directly transferred to the mounting head (see Patent Document 1).

### <Prior Technical Document>

### <Patent Document>

Patent Document 1: JP-A-2006-93321

### SUMMARY OF THE INVENTION

Problems that the Invention is to Solve

In the case of face-up mounting, the pickup head moves reciprocatively between the component supply stage and the component intermediate stage and the mounting head moves reciprocatively between the component intermediate stage and the component mounting stage to perform die bonding. Accordingly, efficient movement of the two heads without wasteful waiting time is an important issue to improve production efficiency.

Therefore, an object of the invention is to provide a component mounting device and a component mounting method in which three stages, i.e. a component supply stage, a component intermediate stage and a component mounting stage are disposed properly to achieve efficient movement of a pickup head and amounting head to thereby improve production efficiency.

### <Means for Solving the Problems>

The component mounting device described in a first aspect of the invention includes: a component supply stage; a pickup head which picks up a component from the component supply stage; a component intermediate stage on which the picked-up component is temporarily placed; a mounting head which receives the component temporarily placed on the component intermediate stage; and a component mounting stage on which the component received by the mounting head is mounted on a board; wherein: the component intermediate stage is disposed at a height between the component supply stage and the component mounting stage.

The component mounting device described in a second aspect of the invention is a component mounting device described in claim 1, wherein: a space where at least one part of the component supply stage moving horizontally can enter is formed below the component intermediate stage.

The component mounting device described in a third aspect of the invention is a component mounting device described in claim 1 or 2, wherein: the component intermediate stage is disposed at a height near the component mounting stage.

The component mounting device described in a fourth aspect of the invention is a component mounting device described in any one of claims 1 to 3, wherein: the pickup head can enter on the component intermediate stage and can be turned over around a horizontal axis; and the mounting head receives the component turned over with the turning-over of the pickup head or the component not turned over and temporarily placed on the component intermediate stage.

The component mounting method described in a fifth aspect of the invention is a component mounting method including the steps of: using a pickup head to pick up a component fed from a component supply stage and temporarily place the component on a component intermediate stage (temporarily placing step); and using a mounting head to receive the component temporarily placed on the component intermediate stage and mount the component on a board (mounting step); wherein: in the temporarily placing step, the component is conveyed from a first height at which the component is fed from the component supply stage, to the component intermediate stage at a second height higher than the first height; in the mounting step, the component is conveyed from the second height at which the component intermediate stage is disposed, to the board at a third height higher than the second height; the temporarily placing step includes a first step of moving the pickup head from the component intermediate stage to the component supply stage to pick up the component from the component supply stage, and a second step of moving the pickup head from the component supply stage to the component intermediate stage to temporarily place the component on the component intermediate stage; the mounting step includes a third step of moving the mounting head from the board to the component intermediate stage to receive the component on the component intermediate stage, and a fourth step of moving the mounting head from the component intermediate stage to the board to mount the component on the board; and the second step in the temporarily placing step and the third step in the mounting step are performed concurrently.

### <Effect of the Invention>

Since the component intermediate stage is disposed at a height between the component supply stage and the component mounting stage, it is possible to keep the balance between the moving distance of the pickup head moving between the component supply stage and the component intermediate stage and the moving distance of the mounting head moving between the component mounting stage and the component intermediate stage. Since the two heads having the moving distances balanced with each other move efficiently without wasteful waiting time, production efficiency in the component mounting device and the component mounting method is improved.

### BRIEF DESCRIPTION OF DRAWING

FIG. 1 is a perspective view of a component mounting device according to an embodiment of the invention.

FIG. 2 is a schematic configuration diagram of the component mounting device according to the embodiment of the invention.

### MODE FOR CARRYING OUT THE INVENTION

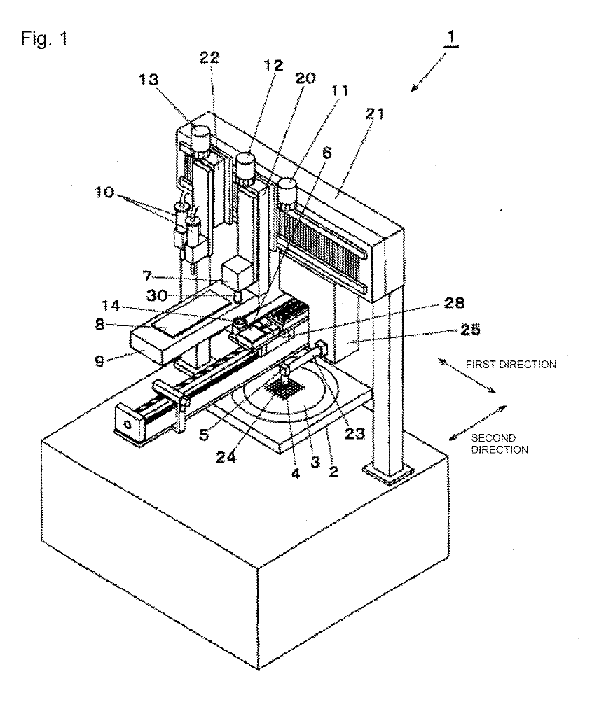

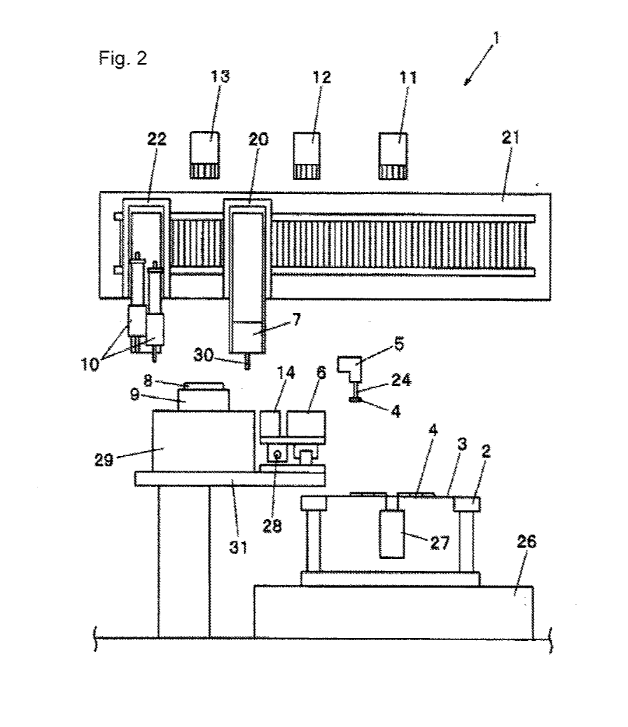

An embodiment of the invention will be described with reference to the drawings. FIG. 1 is a perspective view of a component mounting device according to an embodiment of the invention. FIG. 2 is a schematic configuration diagram of the component mounting device according to the embodiment of the invention.

The overall configuration and operation of the component mounting device will be described first with reference to FIGS. 1 and 2. The component mounting device 1 includes a wafer sheet holder 2, a pickup head 5 which takes a chip 4 out of a wafer sheet 3 held in the wafer sheet holder 2, a chip intermediate table 6 on which the chip 4 taken out of the wafer sheet 3 by the pickup head 5 is placed temporarily, a mounting head 7 which receives the chip 4 taken out of the wafer sheet 3 from the pickup head 5 or the chip intermediate table 6, a board support table 9 which supports a board 8, a dispenser 10 which applies a paste adhesive agent for bonding the chip 4 on the board 8, a first camera 11 for confirming the position and direction of the chip 4 stuck to the wafer sheet 3, a second camera 12 for confirming the position and direction of the chip 4 temporarily placed on the chip intermediate table 6, a third camera 13 for confirming the position of the paste adhesive agent set to be applied on the board 8, and a fourth camera 14 for confirming the position and direction of the chip 4 received by the mounting head 7. Each of the first camera 11, the second camera 12 and the third camera 13 is disposed vertically above a subject to be photographed, so that the region vertically below the camera is used as a photographable region. On the other hand, the fourth camera 14 is disposed vertically below a subject to be photographed, so that the region vertically above the camera is used as a photographable region.

The mounting head 7 can be moved vertically and horizontally (in a first direction) by a first linear motion device 20 and a second linear motion device 21. The dispenser 10 can be moved vertically and horizontally (in the first direction) by a third linear motion device 22 and the second linear motion device 21 in the same manner as the mounting head 7. The pickup head 5 is attached to a front end of a rotary arm 23 extending in a second direction orthogonal to the first direction in a horizontal plane. The rotary arm 23 can rotate around a central axis so that the pickup head 5 can be turned upside down by the rotation of the rotary arm 23 to thereby change the direction of a nozzle 24 upward or downward. The pickup head 5 is attached together with the rotary arm 23 to a fourth linear motion device 25 so that the pickup head 5 can be moved vertically and horizontally (in the first and second directions).

The wafer sheet holder 2 can be moved horizontally (in the first and second directions) at a predetermined height by a fifth linear motion device 26. An up-thrust device 27 of the chip 4 is provided below the wafer sheet holder 2. The up-thrust device 27 is disposed in a position vertically below the first camera 11. The wafer sheet holder 2 moves horizontally relative to the up-thrust device 27 so that any one 4 of chips stuck to the wafer sheet is positioned vertically above the up-thrust device 27. The chip 4 thrust up by the up-thrust device 27 is absorbed by the nozzle 24 of the pickup head 5 so as to be peeled from the wafer sheet 3.

The chip intermediate table 6 can be moved in the first and second directions at a predetermined height by a sixth linear motion device 28, and the board support table 9 can be moved in the first and second directions at a predetermined height by a seventh linear motion device 29. The dispenser 10 and the chip 4 which is absorbed by a nozzle 30 face-down attached to the mounting head 7 move in the first direction while the board 8 moves in the second direction to thereby apply the paste adhesive agent on any position of the board 8 and mount the chip 4 in the position. When the chip 4 is to be mounted face-up, the chip 4 picked up by the pickup head 5 is not turned over but once temporarily placed on the chip intermediate table 6 and picked up by the mounting head 7 so as to be mounted on the board 8. On the contrary, when the chip 4 is to be mounted face-down, the pickup head 5 is turned upside down so that the chip 4 picked up with a face-up posture from the wafer sheet 3 is turned over to a face-down posture and then directly transferred to the mounting head 7.

The arrangement of the wafer sheet holder 2, the chip intermediate table 6 and the board support table 9 will be described next with reference to FIG. 2. The chip intermediate table 6 and the board support table 9 are disposed in parallel to the first direction on a table 31. The board support table 9 is disposed so as to be higher in position than the chip intermediate table 6. The table 31 is supported on a device stand on the side of the board support table 9 so that a space is formed below the chip intermediate table 6. The wafer sheet holder 2 is disposed on the chip intermediate table 6 side of the table 31 so as to be lower in position than the table 31. The space formed below the chip intermediate table 6 is a space where a part of the wafer sheet holder 2 can enter when any chip 4 is positioned vertically above the up-thrust device 27.

When the component mounting device 1 is to mount one chip 4 face-up on the board 8, the pickup head 5 moves between the wafer sheet 3 held in the wafer sheet holder 2 and the chip intermediate table 6 to temporarily place the chip 4 while the mounting head 7 moves between the chip intermediate table 6 and the board 8 supported on the board support table 9 to mount the chip, 4. On this occasion, in the step of temporarily placing the chip 4, the chip 4 is conveyed from a first height at which the wafer sheet 3 is disposed, to the chip intermediate table 6 at a second height higher than the first height. In the step of mounting the chip 4, the chip 4 is conveyed from the second height at which the chip intermediate table 6 is disposed, to the board 8 at a third height higher than the second height. Moreover, the step of temporarily placing the chip 4 includes the steps of: moving the pickup head 5 from the chip intermediate table 6 to the wafer sheet 3 to pick up the chip 4 from the wafer sheet 3 (first step); and moving the pickup head 5 from the wafer sheet 3 to the chip intermediate table 6 to temporarily place the picked-up chip 4 on the chip intermediate table 6 (second step). The step of mounting the chip 4 includes the steps of: moving the mounting head 7 from the board 8 supported on the board support table 9 to the chip intermediate table 6 to receive the chip 4 on the chip intermediate table 6 (third step); and moving the mounting head 7 from the chip intermediate table 6 to the board 8 supported on the board support table 9 to mount the chip 4 on the board 8 (fourth step). In the mounting method based on cooperation of such a plurality of heads, it is desirable that while the second step in the step of temporarily placing the chip 4 is performed, the fourth step in the step of mounting the chip 4 is performed concurrently with the second step so that mounting can be performed at such timing that the mounting head 7 comes to receive the chip 4 just after the pickup head 5 temporarily places the chip 4, in order not to cause the waiting time of any head for movement. It is also desirable that while the first step in the step of temporarily placing the chip 4 is performed, the fourth step in the step of mounting the chip 4 is performed concurrently with the first step so that mounting can be performed at such timing that the mounting head 7 goes to the board 8 for mounting the chip 4 just after the pickup head 5 goes to the wafer sheet 3 for picking up the chip 4. Therefore, in the component mounting device 1, as described above, the chip intermediate table 6 is disposed at a height between the wafer sheet holder 2 and the board support table 9 to thereby keep the balance between moving times of the pickup head 5 and the mounting head 7.

The height at which the chip intermediate table 6 should be disposed specifically is determined in consideration of the moving speeds and horizontal moving distances of the pickup head 5 and the mounting head 7, the time required for picking up, the time required for mounting, etc. Since it generally takes time for alignment, heating, etc. in mounting of the chip, it is preferable in most cases that the chip intermediate table 6 is disposed near the board support table 9 in order to reduce the moving distance of the mounting head 7. When the chip intermediate table 6 is disposed in this manner, it is possible to eliminate such a situation that the chip 4 has not been temporarily placed on the chip intermediate table 6 yet when the mounting head 7 comes to receive the chip 4 or such a situation that the previous chip 4 is still temporarily placed when the pickup head 5 comes to temporarily place another chip 4. Thus, production efficiency is improved.

In the component mounting device 1, because a space where the wafer sheet holder 2 can enter is provided below the table 31, the horizontal moving distance of the pickup head 5 can be reduced so that the chip intermediate table 6 can be disposed nearer to the board support table 9. As a result, the moving distance of the mounting head 7 can be reduced. Accordingly, since the moving distances of the two heads 5 and 7 can be reduced as a whole, production efficiency is improved more greatly.

### <Industrial Applicability>

The invention is useful to a component mounting device and a component mounting method for mounting a component transferred between a plurality of heads on a board.

### DESCRIPTION OF REFERENCE NUMERALS AND SIGNS

1 component mounting device
2 wafer sheet holder
3 wafer sheet
4 chip
5 pickup head
6 chip intermediate table
7 mounting head
8 board
9 board support table

1. A component mounting apparatus, comprising:
a component supply stage;
a pickup head which picks up a component from the component supply stage;
a component intermediate stage on which the picked-up component is temporarily placed;
a mounting head which receives the component temporarily placed on the component intermediate stage; and
a component mounting stage on which the component received by the mounting head is mounted on a board;
the component mounting apparatus characterized in that: the component intermediate stage is disposed at a height between the component supply stage and the component mounting stage.

2. The component mounting apparatus described in claim 1, wherein a space where at least one part of the component supply stage moving horizontally can enter is formed below the component intermediate stage.

3. The component mounting apparatus described in claim 1, wherein the component intermediate stage is disposed at a height near the component mounting stage.

4. The component mounting apparatus described in claim 1, wherein the pickup head can enter on the component intermediate stage and can be turned over around a horizontal axis; and
the mounting head receives the component turned over with the turning-over of the pickup head or the component not turned over and temporarily placed on the component intermediate stage.

5. A component mounting method comprising the steps of:
a temporarily placing step of using a pickup head to pick up a component fed from a component supply stage and temporarily place the component on a component intermediate stage; and
a mounting step of using a mounting head to receive the component temporarily placed on the component intermediate stage and mount the component on a board;
wherein in the temporarily placing step, the component is conveyed from a first height at which the component is fed from the component supply stage, to the component intermediate stage at a second height higher than the first height;
in the mounting step, the component is conveyed from the second height at which the component intermediate stage is disposed, to the board at a third height higher than the second height;
the temporarily placing step includes a first step of moving the pickup head from the component intermediate stage to the component supply stage to pick up the component from the component supply stage, and a second step of moving the pickup head from the component supply stage to the component intermediate stage to temporarily place the component on the component intermediate stage;
the mounting step includes a third step of moving the mounting head from the board to the component intermediate stage to receive the component on the component intermediate stage, and a fourth step of moving the mounting head from the component intermediate stage to the board to mount the component on the board; and
the second step in the temporarily placing step and the third step in the mounting step are performed concurrently.
